(19) United States
(12) Patent Application Publication
(10) Pub. No.: US 2026/0350154 A1
(43) Pub. Date: Nov. 5, 2026

(54) System and method for securing incoming communications

(71) Applicant: Bank of America Corporation, Charlotte, NC (US)

(72) Inventors: Maria Carolina Barraza, Denver, CO (US); Jessica Hope Thompson, Monument, CO (US)

(21) Appl. No.: 19/198,676

(22) Filed: May 5, 2025

(51) Int. Cl. G06F 21/55; G06F 21/56; G06Q 10/0635; H04L 9/40

(52) U.S. Cl. CPC G06F 21/554; G06F 21/56; G06Q 10/0635; H04L 63/14; H04L 63/1408; H04L 63/1416; H04L 63/1425; H04L 63/1433; H04L 63/1441

(57) ABSTRACT

A system includes a memory storing an artificial-intelligence (AI) model and a processor coupled to the memory. The processor detects an incoming communication from an external system directed to a user, extracts a content of the incoming communication, wherein the content comprises at least a text string, and inputs the content to the AI model. The processor executes the AI model to analyze the content. Executing the AI model includes detecting suspicious patterns associated with the content by analyzing the content and determining the incoming communication is malicious based at least in part upon the detected suspicious patterns. The suspicious patterns include language with urgency, a grammatical error, a spelling error, a shift between formal and informal language, a suspicious directive, a repetitive use of words, or an obfuscation of text. The processor further quarantines the incoming communication in a quarantine sector of the memory.

### TECHNICAL FIELD

The present disclosure relates generally to system security, and more specifically, to securing outgoing communications.

### BACKGROUND

In an increasingly interconnected digital landscape, the security of outgoing communications has become a critical concern. Sensitive information transmitted via email, messaging applications, and other communication platforms is vulnerable to interception, unauthorized access, and data breaches.

### SUMMARY

Conventional systems typically block access and communications of internal users of an organization to most external systems except a list of trusted external systems for security. However, the conventional systems suffer from several drawbacks. For example, the list of blocked external systems is static and solely based on a preconfigured, fixed list of network addresses. Thus, conventional systems fail to detect dynamic new external systems that are not previously indicated in the list. Internal users may have access or send out communications to these new external systems. When these new external systems are malicious, they introduce security threats to the organization's computing systems, such as malware infection, vulnerabilities targeted attacks, data leakage, network comprise, resource drain, etc. In another example, due to complete access blocking by conventional systems, some internal users may use private devices to access external systems using the organization's network, which can expose confidential data without the organization's knowledge and introduce security threats to the organization's computing systems. Similarly, an attacker may use the confidential data to target the system vulnerabilities and attack the organization's network to compromise the organization's systems, other internal devices connected to the network, or enable persistent access for attackers. In yet another example, when an access or a communication to an external system by an internal user is allowed, conventional systems do not take further security measures on the identity of the internal user. For example, if a threat analysis within the organization researches a network router and its vulnerability, an attacker may capture the identity data of the threat analysis and connect the identity with the research of the network router and determine that the organization may have a vulnerability related to the network routers within the organization's network. Then the attacker may utilize that vulnerability and gain access to the organization's systems to launch cyber-attacks. Therefore, the drawbacks in the conventional systems lead to the attackers being able to perform malicious operations, including but not limited to, installing or deploying malware, data exfiltration, data destruction, and data manipulation, among others. Further, the drawbacks of the conventional system further lead to data stored in some or all of the computing devices within the organization being compromised as the attackers can access that data via the vulnerabilities. For example, sensitive or confidential data, such as personal information and information about operations of the organization may be compromised.

The system disclosed in the present application provides a technical solution to the problems discussed above. The disclosed system uses an AI model to detect whether an outgoing communication from an internal user has confidential data with respect to the user's identity category. When the disclosed system detects that the user attempts send a communication to an external system, the system inputs the communication and the user's identity category to the AI model. The system further executes the AI model to analyze the communication with the identity category being applied as a condition. If there is confidential data being sent out, the AI model can either block the communication from being sent out or mitigate the confidential data. If the AI model determines to mitigate the confidential data, the system can modify the communication by applying migration algorithms decided by the AI model. The system can further mask the identity category of the user and remove or obfuscate the metadata (e.g., geolocation or IP address) of the outgoing communication before the communication is transmitted to the external system.

In one embodiment, the disclosed system includes a memory operable to store an artificial-intelligence (AI) model trained to detect confidential data in communications and mitigate communications with confidential data. The AI model was trained on a training dataset including a plurality of identity categories categorizing user roles within organizations, a plurality of masked identity categories mapping to the respective identity categories, a plurality of communications comprising confidential data corresponding to each of the plurality of identity categories, and/or a plurality of communications comprising no confidential data corresponding to each of the plurality of identity categories. The disclosed system further includes a processor operably coupled to the memory. The processor is configured to detect a first request by a first user to send a first communication to an external system. The first user is associated with a first identity category. The processor is further configured to input the first communication and the first identity category to the AI model. The processor is further configured to execute the AI model to analyze the first communication with the first identity category being applied as a condition for analyzing the first communication. Executing the AI model outputs a detection of confidential data in the first communication under the condition of the first identity category and one or more mitigation mechanisms associated with the confidential data. The one or more mitigation mechanisms include removing the confidential data from the first communication or obfuscating the confidential data. The processor is further configured to modify the first communication when the one or more mitigation mechanisms include removing the confidential data from the first communication or obfuscating the confidential data. The processor is further configured to transmit the modified first communication to the external system.

In one embodiment, the modified first communication includes the obfuscated confidential data or no confidential data.

In one embodiment, executing the AI model further outputs a masked identity category for the first identity category. The modified first communication is sent to the external system with the masked identity category.

In one embodiment, the first request is associated with a set of metadata. The processor is further configured to obfuscate the set of metadata. The modified first communication is sent to the external system with the set of obfuscate metadata.

In one embodiment, the set of metadata include one or more of a geolocation or an internet protocol (IP) address associated with the first user.

In one embodiment, the processor is further configured to remove the set of metadata from the first request. The modified first communication is sent to the external system without the set of metadata.

In one embodiment, detecting the first request by the first user to send the first communication to the external system includes detecting the first communication is inputted into a web browser on a user device associated with the first user.

The disclosed system and methods provide the practical application of improving network monitoring and detection of confidential data at the communication level by training and implementing an AI model to proactively detect confidential data in an outgoing communication from an internal user when considering the user's identity category. Thus, by implementing the disclosed system, the network and system security of the organization is increased. In particular, the network and system security of the organization is increased because the disclosed system trains an AI model that detects confidential data in communications and mitigate communications using a training dataset including identity categories, masked identity categories mapping to the respective identity categories, communications comprising confidential data corresponding to each identity category, and communications comprising no confidential data corresponding to each identity category. The disclosed system executes the trained AI model on an outgoing communication from a user with the user's identity category being applied as a condition to detect confidential data in the communication. The conventional systems would have failed to detect confidential data in a communication because they merely block communications to most external systems and allow communications to a list of trusted external systems without analyzing each communication with respect the corresponding user's identity category. In response to detecting that the outgoing communication has confidential data, the disclosed system either blocks the outgoing communication or removes or obfuscates the confidential data. Thus, the confidential data is not transmitted to the external system. Further, the disclosed system removes the metadata of the communication before transmitting the communication to the external system. In this manner, the disclosed system prevents attackers from identifying vulnerabilities from the metadata or targeting the user in phishing or social engineering attacks. The disclosed system additionally maps the identity category of the user to a masked identity category before transmitting the communication to the external system. In this manner, the disclosed system prevents attackers from identifying the user from the identity category and targeting the user in phishing or social engineering attacks.

Technical advantages of certain embodiments of this disclosure may include one or more of the following. The disclosed system and methods can proactively mitigate confidential data in a communication and prevent the confidential data, metadata of the communication, and user identity category from being utilized by attackers. Therefore, the disclosed system reduces the probability of cyber-attacks described above, such as data exfiltration, data destruction, and data manipulation, among others. In particular, reducing the probability of cyber-attacks leads to technical advantages, such as protecting sensitive data from unauthorized access, which can increase the accuracy and consistency of stored data by preventing unauthorized modifications and can also help against the loss of data due to data exfiltration. Other technical advantages include minimizing system downtime due to cyber-attacks and enabling faster and more effective incident response. These technical advantages lead to additional technical advantages such as enhanced network resilience, increased operational continuity, and faster recovery times. By proactively identifying and addressing potential issues, minimizing system downtime strengthens the overall stability and robustness of the system, reducing the likelihood of unexpected outages due to cyber-attacks. Effective monitoring and rapid response mechanisms allow for quicker restoration of system functionality in case of failures, minimizing the impact of any downtime that does occur due to cyber-attacks. Reduced downtime also helps prevent data loss by ensuring consistent system operation and reducing the risk of corruption during unexpected outages.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system that is configured for securing outgoing communications.

FIGS. 2A-2B illustrate an example flowchart of a method for securing outgoing communications.

### DETAILED DESCRIPTION

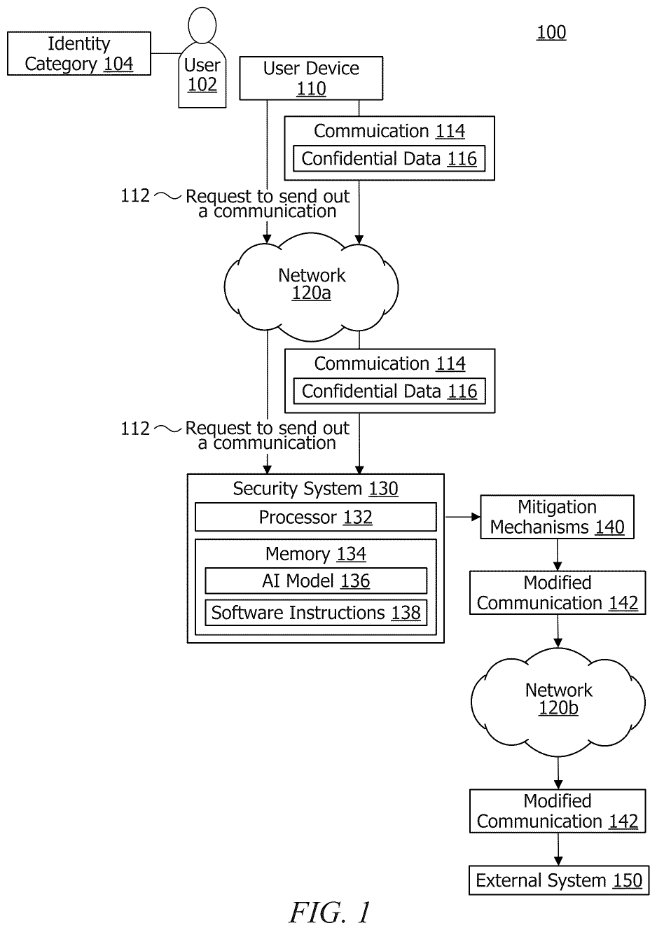

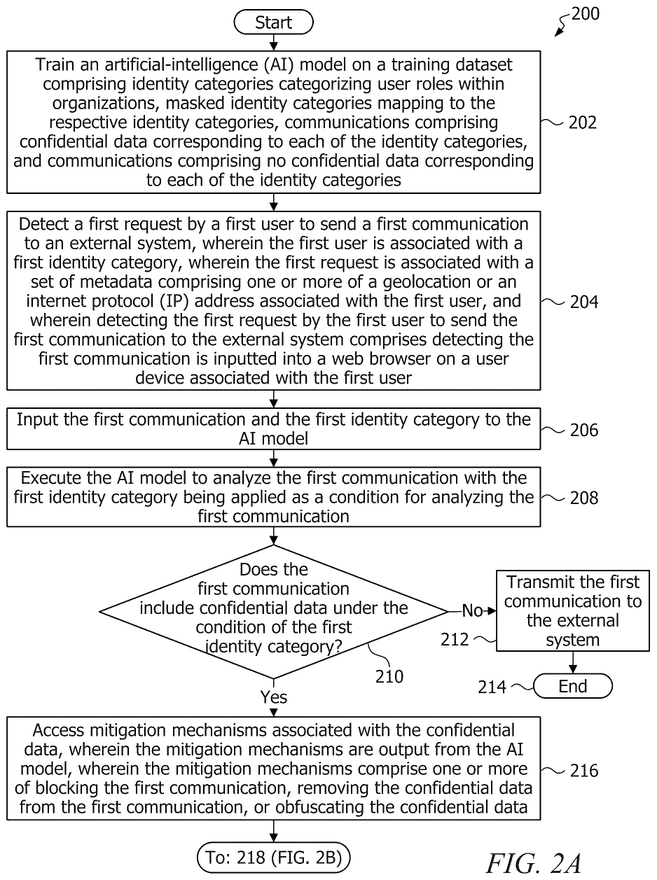

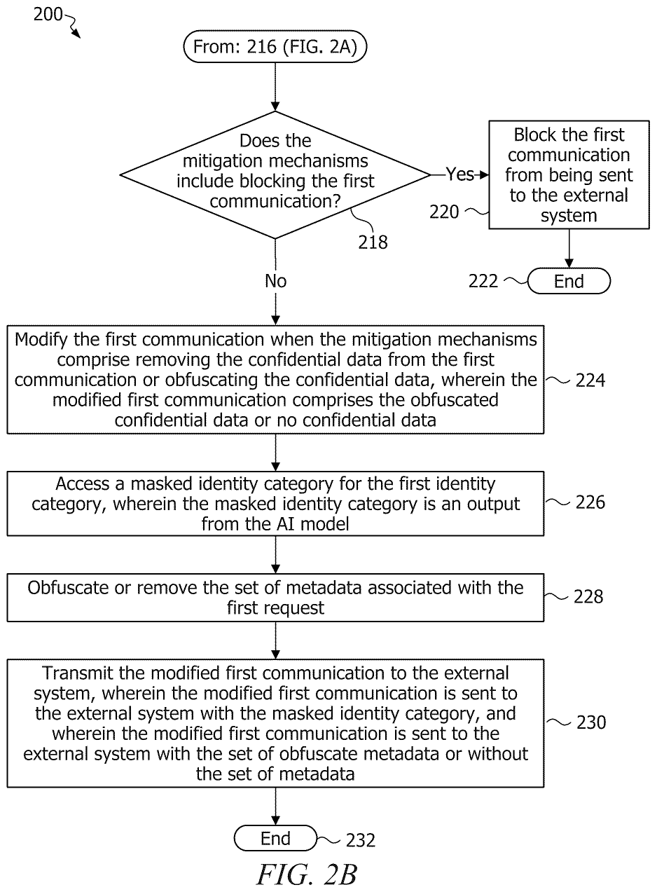

As described above, conventional systems may fail to address the security risks of outgoing communications. This disclosure provides various systems and methods to use an AI model to detect whether an outgoing communication has confidential data. If there is confidential data being sent out, the AI model can either block it from being sent out or remove or obfuscate the confidential data. FIG. 1 illustrates one embodiment of a system that is configured for securing outgoing communications. FIGS. 2A-2B illustrate an example flowchart of a method for securing outgoing communications.

### Example System for Securing Outgoing Communications

FIG. 1 illustrates one embodiment of a system 100 that is configured for securing outgoing communications. System 100 comprises a user device 110 associated with a user 102, one or more networks 120, a security system 130, and an external system 150. In some embodiments, system 100 may not have all of the components listed and/or may have other elements instead of, or in addition to, those listed above.

### Architecture Components

### User Device

Examples of user device 110 include, but are not limited to, computers, laptops, mobile devices (e.g., smart phones or tablets), servers, clients, or any other suitable type of device associated with user 102. User device 110 is generally configured to capture data and send instructions/data to security system 130. For example, the instructions from user device 110 to security system 130 may comprise a request 112 to send out a communication. As another example, the data captured by user device 110 may comprise a communication 114. As yet another example, the data from user device 110 to security system 130 may include the communication 114. In other examples, the data may comprise any suitable type of data. The instructions may comprise any suitable type or number of commands for processing the data.

### Network

Network 120 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 120 may be configured to support any suitable type of communication protocol as would be appreciated by one of ordinary skill in the art.

### External System

External system 150 is generally any third-party device that is configured to process data and communicate with devices, systems (e.g., security system 130), etc. External system 150 is generally configured to receive data from security system 130. For example, the data may include modified communication 142.

### Security System

Security system 130 is generally any device that is configured to process data and communicate with devices (e.g., user device 110), systems (e.g., external system 150), etc. Security system 130 is generally configured to perform operations described further below in conjunction with method 200 described in FIGS. 2A-2B. In an embodiment, security system 130 comprises one or more processors 132 in signal communication with a memory 134.

Processors 132 are operably coupled to the memory 134. A processor 132 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). A processor 132 may be a programmable logic device, a microcontroller, a microprocessor, or any suitable combination of the preceding. Processors 132 are communicatively coupled to and in signal communication with memory 134. Processors 132 are configured to process data. For example, a processor 132 may be 8-bit, 16-bit, 32-bit, 64-bit or of any other suitable architecture. A processor 132 may include an arithmetic logic unit (ALU) for performing arithmetic and logic operations, processors register that supply operands to the ALU and store the results of ALU operations, and a control unit that fetches software instructions 138 from memory 134 and execute them by directing the coordinated operations of the ALU, registers and other components. Processors 132 are configured to implement various software instructions 138. For example, processors 132 are configured to execute software instructions 138 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

Memory 134 may be volatile or non-volatile and may comprise a read-only memory (ROM), random-access memory (RAM), ternary content-addressable memory (TCAM), dynamic random-access memory (DRAM), and static random-access memory (SRAM). Memory 134 may be implemented using one or more disks, tape drives, solid-state drives, and/or the like. Memory 134 is operable to store the software (e.g., AI model 136), and/or any other data or software instructions 138.

AI model 136 can detect confidential data in communications and mitigate communications with confidential data. AI model 136 can be trained on a training dataset comprising a plurality of training data using appropriate algorithms. The training data may include a plurality of identity categories categorizing user roles within organizations, a plurality of masked identity categories mapping to the respective identity categories, a plurality of communications comprising confidential data corresponding to each of the plurality of identity categories, and a plurality of communications comprising no confidential data corresponding to each of the plurality of identity categories.

To generate the training data, security system 130 may collect user roles within organizations and the responsibilities of these user roles and categorize user roles into identity categories. For example, a user role of cybersecurity analyst and a user role of information security officer can both have the identity category of security. Security system 130 may further collect historical communications without confidential data with respect to different identity categories. For example, a communication including “hot market” may be considered confidential for the identity category of marketing but not confidential for the identity category of helpdesk. Security system 130 may also collect historical communications with confidential data with respect to different identity categories. Security system 130 may then map the identity categories to masked identity categories, given that users with the masked identity categories can still fulfill their responsibilities. For example, a masked identity category for an identity category of cybersecurity analysts may be students studying cybersecurity instead of a salesperson.

Software instructions 138 may comprise any suitable set of instructions, logic, rules, or code operable to execute processors 132. Software instructions 138, when executed by processors 132, cause processors 132 to perform one or more functions described herein. For example, when software instructions 138 are executed, processors 132 execute AI model 136 to analyze communication 114 to determine whether there is confidential data 116 in communication 114. When software instructions 138 are executed, processors 132 further execute the AI model 136 to generate modified communication 142 by applying mitigation mechanisms 140 to communication 114.

### Operational Flow

In an embodiment, user 102 associated with identity category 104 may submit a request 112 to send out a communication 114 to external system 150 using user device 110. For example, user 102 may request to send out an email, in which the email is the communication 114. As another example, user 102 may be on a website associated with external system 150 and type in a query in a search bar on the website, in which the query is the communication 114. In an embodiment, a plugin installed on a web browser of user device 110 may capture the typed query in the above example. Communication 114 may include confidential data 116.

When security system 130 receives the request 112 to send out a communication and communication 114 via network 120a, security system 130 may execute AI model 136 to analyze communication 114 with the user's 102 identity category 104 being applied as a condition for analyzing communication 114. AI model 136 may detect that there is confidential data 116 in communication 114. AI model 136 may additionally output one or more mitigation mechanisms 140 for communication 114 containing confidential data 116. For example, the mitigation mechanisms 140 may include blocking communication 114 from being sent to external system 150, removing confidential data 116 from communication 114, or obfuscating confidential data 116. When the mitigation mechanism 140 is blocking communication 114, security system 130 may block communication 114 from being sent to external system 150. When the mitigation mechanism 140 is removing confidential data 116 from communication 114 or obfuscating confidential data 116, security system 130 may generate modified communication 142 by modifying communication 114. Modified communication 142 may include the obfuscated confidential data or no confidential data.

In an embodiment, executing the AI model 136 further outputs a masked identity category for the user's 102 identity category 104. The masked identity category can enable the first user to still fulfill their goal associated with the first communication 114 without introducing security risks to the organization of the first user. For example, if the user's 102 identity category 104 is cybersecurity analysts and typed in a query on a website of an external system 150, the masked identity category may be students studying cybersecurity so that the user 102 can still retrieve information from the external system 150 without causing security risks. By masking the first user's 102 real identity category 104, security system 130 can prevent an attacker leveraging the first user's 102 real identity category 104 to perform reverse engineering and launch a cyber-attack. For example, when a threat analyst sends out a query out for some information, the identity category 104 may be masked as a researcher so that the person can still get information back without introducing a risk to the bank.

In an embodiment, communication 114 may be associated with a set of metadata. For example, the set of metadata may include a geolocation or an internet protocol (IP) address of user device 110. Security system 130 may obfuscate the set of metadata or remove the set of metadata from communication 114.

After all the aforementioned security operations, security system 130 may transmit modified communication 142 to external system 150 via network 120b. Modified communication 142 is sent to external system 150 with the masked identity category. Modified communication 142 is sent to external system 150 with the set of obfuscate metadata or without the set of metadata.

In the scenario where the user 102 expects to receive data/information from the external system 150 responsive to the communication 114 transmitted to the external system 150, because the communication 114 is associated with a masked identity category of the user 102, security system 130 may execute the AI model 136 on the data/information from the external system 150 to make them suitable/useful for the real identity category 104. For example, after the user 102 submits a query on a website of the external system 150, the user 102 expects to get query results. Since security system 130 used a masked identity category for the user's 102 real identity category 104 (e.g., student researching cybersecurity for cybersecurity analyst), the results for the query may be tailored for a student researching cybersecurity rather than a cybersecurity analyst. As such, security system 130 may execute the AI model 136 on the results to generate results tailored for a cybersecurity analyst.

### Example Methods for Securing Outgoing Communications

FIGS. 2A-2B illustrates an example flowchart of a method 200 for securing outgoing communications. Modifications, additions, or omissions may be made to method 200. Method 200 may include more, fewer, or other operations. For example, operations may be performed in parallel or in any suitable order. While at times discussed as security system 130, or components of any of thereof performing operations, any suitable system or components of the system may perform one or more operations of the method 200. For example, one or more operations of method 200 may be implemented, at least in part, in the form of software instructions (e.g., software instructions 138 of FIG. 1), stored on non-transitory, tangible, machine-readable media (e.g., memory 134 of FIG. 1) that when run by one or more processors (e.g., processors 132 of FIG. 1) may cause the one or more processors to perform operations 202-232.

After start, security system 130 trains an artificial-intelligence (AI) model 136 on a training dataset at operation 202. The training dataset includes identity categories categorizing user roles within organizations, masked identity categories mapping to the respective identity categories, communications comprising confidential data corresponding to each of the identity categories, and communications comprising no confidential data corresponding to each of the identity categories. To generate the training data, security system 130 may collect user roles within organizations and the responsibilities of these user roles and categorize user roles into identity categories. For example, a user role of cybersecurity analyst and a user role of information security officer can both have the identity category of security. Security system 130 may further collect historical communications without confidential data with respect to different identity categories. For example, a communication including “hot market” may be considered confidential for the identity category of marketing but not confidential for the identity category of helpdesk. Security system 130 may also collect historical communications with confidential data with respect to different identity categories. Security system 130 may then map the identity categories to masked identity categories, given that users with the masked identity categories can still fulfill their responsibilities. For example, a masked identity category for an identity category of cybersecurity analysts may be students studying cybersecurity instead of a salesperson. The trained AI model 136 can detect confidential data in communications and mitigate communications with confidential data.

At operation 204, security system 130 detects a first request 112 by a first user 102 to send a first communication 114 to an external system 150. For example, the first user 102 may request to send out an email, in which the email is the first communication 114. The first user 102 is associated with a first identity category 104, e.g., a cybersecurity analyst. The first request 112 is associated with a set of metadata comprising one or more of a geolocation or an internet protocol (IP) address associated with the first user 102. In an embodiment, detecting the first request 112 by the first user 102 to send the first communication 114 to the external system 150 includes detecting the first communication 114 is inputted into a web browser on a user device 110 associated with the first user 102. For example, the first user 102 may be on a website associated with external system 150 and type in a query in a search bar on the website, in which the query is the first communication 114.

At operation 206, security system 130 inputs the first communication 114 and the first identity category 104 to the AI model 136.

At operation 208, security system 130 executes the AI model 136 to analyze the first communication 114 with the first identity category 104 being applied as a condition for analyzing the first communication 114. The first identify category 104 is applied as a condition because the same communication 114 may have different confidentiality for different identity categories 104. For example, a communication 114 including “hot market” may be considered confidential for the identity category 104 of marketing but not confidential for the identity category 104 of helpdesk.

At operation 210, security system 130 determines whether the first communication 114 includes confidential data 116 under the condition of the first identity category 104. If the first communication 114 does not include confidential data 116 under the condition of the first identity category 104, method 200 proceeds to operation 212.

At operation 212, security system 130 transmits the first communication 114 to the external system 150. For example, security system 130 may send the mail to the external system 150. As another example, security system 130 may send the query typed on the website of the external system to the external system 150. Method 200 then ends at operation 214.

If the first communication 114 includes confidential data 116 under the condition of the first identity category 104, method 200 proceeds to operation 216.

At operation 216, security system 130 accesses mitigation mechanisms 140 associated with the confidential data 116. The mitigation mechanisms 140 are output from the AI model 136. In certain embodiments, the mitigation mechanisms 140 include one or more of blocking the first communication 114, removing the confidential data 116 from the first communication 114, or obfuscating the confidential data 116.

At operation 218, security system 130 determines whether the mitigation mechanisms 140 include blocking the first communication 114. If the mitigation mechanisms 140 include blocking the first communication 114, method 200 proceeds to operation 220.

At operation 220, security system 130 blocks the first communication 114 from being sent to the external system 150.

Method 200 then ends at operation 222.

If the mitigation mechanisms 140 do not include blocking the first communication 114, method 200 proceeds to operation 224.

At operation 224, security system 130 modifies the first communication 114 when the mitigation mechanisms 140 include removing the confidential data 116 from the first communication 114 or obfuscating the confidential data 116. Accordingly, the modified first communication 142 includes the obfuscated confidential data or no confidential data.

At operation 226, security system 130 accesses a masked identity category for the first identity category 104. The masked identity category is an output from the AI model 136. The masked identity category can enable the first user to still fulfill their goal associated with the first communication 114. For example, if the first user's 102 identity category 104 is cybersecurity analysts, the masked identity category may be students studying cybersecurity. By masking the first user's 102 real identity category 104, security system 130 can prevent an attacker leveraging the first user's 102 real identity category to perform reverse engineering and launch a cyber-attack.

At operation 228, security system 130 obfuscates or removes the set of metadata associated with the first request 112. For example, security system 130 may obfuscate the IP address or remove the IP address associated with the first request 112.

At operation 230, security system 130 transmits the modified first communication 142 to the external system 150. The modified first communication 142 is sent to the external system 150 with the masked identity category. In addition, the modified first communication 142 is sent to the external system 150 with the set of obfuscate metadata or without the set of metadata.

Method 200 then ends at operation 232.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store:
an artificial-intelligence (AI) model trained to detect malicious communications, wherein the AI model was trained on a training dataset comprising a plurality of identity categories categorizing user roles within organizations, a plurality of legitimate communications corresponding to each of the plurality of identity categories, a plurality of malicious communications corresponding to each of the plurality of identity categories; and
a processor, operably coupled to the memory, and configured to:
detect an incoming communication from an external system directed to a first user;
extract a content of the incoming communication, wherein the content comprises at least a text string;
input the content to the AI model;
execute the AI model to analyze the content, wherein executing the AI model comprises:
detecting one or more suspicious patterns associated with the content by analyzing the content, wherein the suspicious patterns comprise one or more of language with urgency, a grammatical error, a spelling error, a shift between formal and informal language, a suspicious directive, a repetitive use of words, or an obfuscation of text; and
determining the incoming communication is malicious based at least in part upon the detected suspicious patterns; and
quarantine the incoming communication in a quarantine sector of the memory.

2. The system of claim 1, wherein the processor is further configured to:
extract an identity present in the incoming communication; and
input the identity to the AI model, wherein executing the AI model further comprises:
determining an abnormal association between the first user and the identity present in the incoming communication, wherein the abnormal association is determined based at least in part upon one or more of no prior interactions between the first user and the identity present in the incoming communication or a misalignment of a geolocation of the identity present in the incoming communication and expected geolocations associated with the first user; and
determining the incoming communication is malicious further based at least in part upon the abnormal association between the first user and the identity present in the incoming communication.

3. The system of claim 1, wherein the processor is further configured to:
within the quarantine sector of the memory, detect a malicious code, a malicious link, a malicious attachment, or a fake form contained in the incoming communication; and
delete one or more of the malicious code, malicious link, malicious attachment, or fake form from the incoming communication.

4. The system of claim 1, wherein the processor is further configured to:
block the incoming communication from being transmitted to a user device associated with the first user.

5. The system of claim 1, wherein the first user is associated with a first identity category categorizing a role of the first user within an organization, wherein the processor is further configured to:
input the first identity category to the AI model, wherein executing the AI model further comprises:
analyzing the extracted content and the first identity category to determine an abnormal association between the content and the first identity category, wherein the abnormal association is determined based at least in part upon one or more references in the content that are unrelated to the first identity category; and
determining the incoming communication is malicious further based at least in part upon the abnormal association between the content and the first identity category.

6. The system of claim 1, wherein the incoming communication is originated from a second user, wherein the processor is further configured to:
access historical communications from the second user; and
input the historical communication into the AI model, wherein executing the AI model further comprises:
comparing contents of the historical communications and the content of the incoming communication to detect one or more anomalies of the content; and
determining the incoming communication is malicious further based at least in part upon the detected anomalies of the content of the incoming communication.

7. The system of claim 1, wherein the incoming communication is originated from a domain that was previously validated, wherein the processor is further configured to:
detect a plurality of second incoming communications originated from the domain;
execute the AI model on the plurality of second incoming communications to determine that the plurality of second incoming communications are malicious; and
invalidate the domain by blocking incoming communications from the domain.

8. A method comprising, by a computing system:
detecting an incoming communication from an external system directed to a first user;
extracting a content of the incoming communication, wherein the content comprises at least a text string;
inputting the content to an artificial-intelligence (AI) model trained to detect malicious communications, wherein the AI model was trained on a training dataset comprising a plurality of identity categories categorizing user roles within organizations, a plurality of legitimate communications corresponding to each of the plurality of identity categories, a plurality of malicious communications corresponding to each of the plurality of identity categories;
executing the AI model to analyze the content, wherein executing the AI model comprises:
detecting one or more suspicious patterns associated with the content by analyzing the content, wherein the suspicious patterns comprise one or more of language with urgency, a grammatical error, a spelling error, a shift between formal and informal language, a suspicious directive, a repetitive use of words, or an obfuscation of text; and
determining the incoming communication is malicious based at least in part upon the detected suspicious patterns; and
quarantining the incoming communication in a quarantine sector of a memory associated with the computing system.

9. The method of claim 8, further comprising:
extracting an identity present in the incoming communication; and
inputting the identity to the AI model, wherein executing the AI model further comprises:
determining an abnormal association between the first user and the identity present in the incoming communication, wherein the abnormal association is determined based at least in part upon one or more of no prior interactions between the first user and the identity present in the incoming communication or a misalignment of a geolocation of the identity present in the incoming communication and expected geolocations associated with the first user; and
determining the incoming communication is malicious further based at least in part upon the abnormal association between the first user and the identity present in the incoming communication.

10. The method of claim 8, further comprising:
within the quarantine sector of the memory, detecting a malicious code, a malicious link, a malicious attachment, or a fake form contained in the incoming communication; and
deleting one or more of the malicious code, malicious link, malicious attachment, or fake form from the incoming communication.

11. The method of claim 8, further comprising:
blocking the incoming communication from being transmitted to a user device associated with the first user.

12. The method of claim 8, wherein the first user is associated with a first identity category categorizing a role of the first user within an organization, the method further comprising:
inputting the first identity category to the AI model, wherein executing the AI model further comprises:
analyzing the extracted content and the first identity category to determine an abnormal association between the content and the first identity category, wherein the abnormal association is determined based at least in part upon one or more references in the content that are unrelated to the first identity category; and
determining the incoming communication is malicious further based at least in part upon the abnormal association between the content and the first identity category.

13. The method of claim 8, wherein the incoming communication is originated from a second user, the method further comprising:
accessing historical communications from the second user; and
inputting the historical communication into the AI model, wherein executing the AI model further comprises:
comparing contents of the historical communications and the content of the incoming communication to detect one or more anomalies of the content; and
determining the incoming communication is malicious further based at least in part upon the detected anomalies of the content of the incoming communication.

14. The method of claim 8, wherein the incoming communication is originated from a domain that was previously validated, the method further comprising:
detecting a plurality of second incoming communications originated from the domain;
executing the AI model on the plurality of second incoming communications to determine that the plurality of second incoming communications are malicious; and
invalidating the domain by blocking incoming communications from the domain.

15. A non-transitory computer-readable medium storing instructions that, when executed by one or more processors of a system, cause the one or more processors to:
detect an incoming communication from an external system directed to a first user;
extract a content of the incoming communication, wherein the content comprises at least a text string;
input the content to an artificial-intelligence (AI) model trained to detect malicious communications, wherein the AI model was trained on a training dataset comprising a plurality of identity categories categorizing user roles within organizations, a plurality of legitimate communications corresponding to each of the plurality of identity categories, a plurality of malicious communications corresponding to each of the plurality of identity categories;
execute the AI model to analyze the content, wherein executing the AI model comprises:
detecting one or more suspicious patterns associated with the content by analyzing the content, wherein the suspicious patterns comprise one or more of language with urgency, a grammatical error, a spelling error, a shift between formal and informal language, a suspicious directive, a repetitive use of words, or an obfuscation of text; and
determining the incoming communication is malicious based at least in part upon the detected suspicious patterns; and
quarantine the incoming communication in a quarantine sector of a memory associated with the system.

16. The non-transitory computer-readable medium of claim 15, wherein the instructions further cause the one or more processors to:
extract an identity present in the incoming communication; and
input the identity to the AI model, wherein executing the AI model further comprises:
determining an abnormal association between the first user and the identity present in the incoming communication, wherein the abnormal association is determined based at least in part upon one or more of no prior interactions between the first user and the identity present in the incoming communication or a misalignment of a geolocation of the identity present in the incoming communication and expected geolocations associated with the first user; and
determining the incoming communication is malicious further based at least in part upon the abnormal association between the first user and the identity present in the incoming communication.

17. The non-transitory computer-readable medium of claim 15, wherein the instructions further cause the one or more processors to:
within the quarantine sector of the memory, detect a malicious code, a malicious link, a malicious attachment, or a fake form contained in the incoming communication; and
delete one or more of the malicious code, malicious link, malicious attachment, or fake form from the incoming communication.

18. The non-transitory computer-readable medium of claim 15, wherein the instructions further cause the one or more processors to:
block the incoming communication from being transmitted to a user device associated with the first user.

19. The non-transitory computer-readable medium of claim 15, wherein the first user is associated with a first identity category categorizing a role of the first user within an organization, wherein the instructions further cause the one or more processors to:
input the first identity category to the AI model, wherein executing the AI model further comprises:
analyzing the extracted content and the first identity category to determine an abnormal association between the content and the first identity category, wherein the abnormal association is determined based at least in part upon one or more references in the content that are unrelated to the first identity category; and
determining the incoming communication is malicious further based at least in part upon the abnormal association between the content and the first identity category.

20. The non-transitory computer-readable medium of claim 15, wherein the incoming communication is originated from a second user, wherein the instructions further cause the one or more processors to:
access historical communications from the second user; and
input the historical communication into the AI model, wherein executing the AI model further comprises:
comparing contents of the historical communications and the content of the incoming communication to detect one or more anomalies of the content; and
determine the incoming communication is malicious further based at least in part upon the detected anomalies of the content of the incoming communication.
